(19) United States
(12) Patent Application Publication
(10) Pub. No.: US 2008/0313259 A1
(43) Pub. Date: Dec. 18, 2008

(54) IN-FLIGHT ENTERTAINMENT AND CABIN INTEGRATION SERVICE ORIENTED SOFTWARE ARCHITECTURE AND METHOD

(75) Inventor: Paulo Correa, Laguna Niguel, CA (US)

Correspondence Address: DRINKER BIDDLE & REATH LLP;ATTN: PATENT DOCKET DEPT., 191 N. WACKER DRIVE, SUITE 3700, CHICAGO, IL, 60606, US

(73) Assignee: Thales Avionics, Inc., Irvine, CA (US)

(21) Appl. No.: 12/112,173

(22) Filed: Apr. 30, 2008

Related U.S. Application Data
(60) Provisional application No. 60/924,100, filed on Apr. 30, 2007.

(51) Int. Cl. G06F 15/16; G06Q 10/00; G06Q 50/00; G06F 9/46

(52) U.S. Cl. 709/201; 705/7; 718/105

(57) ABSTRACT

A software architecture for integrating an in-flight entertainment system and a vehicle cabin functions system. A first network serves the in-flight entertainment system, and a second network serves the vehicle cabin functions system. A first set of common functions is available via the first network, and a second set of common functions is available via the second network. At least one interface links the first and second sets of common functions and is adapted to link at least one additional service to at least one of the first and second networks.

### CROSS REFERENCE TO RELATED APPLICATIONS

The present application claims the benefit of U.S. Provisional Application No. 60/924,100, filed Apr. 30, 2007, herein incorporated by reference.

### BACKGROUND

The present invention relates to a system and method for expanding in-flight (or, generically, in-operation) entertainment (IFE) and cabin functions throughout a cabin of a vehicle, such as an aircraft. More particularly, the present invention relates to implementing new services for airplane passengers and crew without having to redesign software any time a service is added or removed, and at the same time maintaining intact the avionics specificities of an integrated IFE and cabin functions system. The implementation is provided utilizing a Service Oriented Architecture for software design.

Related IFE systems implement complex functions like audio and video on demand (AVoD) services, as well as simple functions like volume control. Nevertheless, the demand for more sophisticated functions and services has challenged the manufactures of IFE systems to add more features and improve performance while still complying with applicable regulations related to safety, electromagnetic interference, power consumption, and weight (i.e., to improve fuel efficiency). Moreover, users have additionally experienced a multiplicity of applications and facilities in their homes, in their personal lives (e.g., mobile technologies), and in their workplaces that they desire to have available in a vehicle cabin while traveling.

Today's airlines and travelers are increasingly demanding. They are more individualistic, independent, and informed. They welcome services that appeal to their emotions as well as their practical needs, and for an airline, the provision of such services can differentiate them from their competitors. Therefore, there is a need to satisfy increasing demands by travelers, crews, and manufacturers for access to technologies that are available outside of vehicles. Such technologies include new 3D games, audio and video on demand with the features that passengers experience in their homes, the ability to surf the Internet, access e-mail, and any services that passengers currently enjoy with today's technology.

In the known architectures that are presently used in vehicles, services and functions are specified and supported by single logical functions performing specialized features for the service. Each service appears as an island with its own specific functions. In the absence of any common framework, every service may have to be design and implemented from scratch.

A Service Oriented Architecture (SOA) has developed over time due to the requirement of a comprehensive architecture where services could be added or suppressed without the re-development or re-deployment of other services. This architecture also makes it simple to add a service from another provider without disrupting the existing system. An SOA is not tied to a specific technology, and the key to this architecture is independent services with defined interfaces that can be called to perform their tasks in a standard way.

The SOA model decouples underlying network resources from service development and delivery. Services are then allowed to evolve independently of each other. This simplifies service creation, composition, and delivery, and should in turn enable rapid innovation—mostly because the developer is not required to understand the underlying network technology on which the service is built in.

As more and more software systems are built, similar situations and patterns appear. It is desirable to reuse the functionality of existing systems rather than building them from scratch. One problem resides in the dependencies between functions and services. Many of the dependencies are real dependencies, and some are artificial. When designing software, developers are able to minimize the artificial dependencies and stay only with the real dependencies, which achieves what is called “loose coupling software”. The “separation of concerns” is considered as a principle of software engineering and is achievable in loose coupling software.

SOA achieves loose coupling among interacting software parts and agents in two ways: first, a small set of simple and ubiquitous interfaces are provided to all participating software agents. Only generic semantics are encoded at the interfaces, and the interfaces should be universally available for all providers and consumers. Second, descriptive messages are constrained by an extensible schema delivered through the interfaces. No, or only minimal, system behavior is prescribed by messages. A schema limits the vocabulary and structure of messages. An extensible schema allows new versions of services to be introduced without breaking existing services.

Interfacing is fundamentally important-if interfaces do not work, the systems do not work. An interface needs to prescribe system behavior with correct implementation across different platforms and languages. Remote interfaces are also the slowest part of most distributed applications. Instead of building new interfaces for each application, it makes sense to reuse a few generic ones for all applications.

Since only a few generic interfaces are available, application-specific semantics are expressed in messages. Any kind of message can be sent over the interfaces, but there are a few rules to follow before one can say that the architecture is service oriented.

First, the messages must be descriptive, rather than instructive, because the service provider is responsible for solving the problem.

Second, service providers will be unable to understand the request if the messages are not written in a format, structure, and vocabulary that is understood by all parties. Limiting the vocabulary and structure of messages is a necessity for any efficient communication. The more restricted a message is, the easier it is to understand the message, although this comes at the expense of reduced extensibility.

Third, extensibility is vitally important since the world is an ever-changing place and so is any environment in which a software system lives. These changes demand corresponding changes in the software system, clients, providers, and the messages they exchange. Restriction and extensibility are deeply entwined, and both are needed, although maximizing one comes at the expense of minimizing the other, meaning that establishing the right balance is important.

Fourth, an SOA must have a mechanism that enables a client to discover a service in the context of a service sought by the client. The mechanism can be really flexible, and it does not have to be a centralized registry.

The charter of SOA is to eliminate applications as they exist today (with all of their drawbacks, just described) and create software systems as a set of interacting services, coordinated by business requirements. Every service implements a particular business requirement, which is defined in the context of the overall solution that has to be implemented.

A comparison between an application-centric and SOA implementation can be seen in the table below.

TABLE 1
Comparison of Application Centric and SOA Implementations

| | Application-centric | |
|---|---|---|
| Characteristic | architecture | SOA |
| Design and | Function oriented | Coordination oriented |
| implementation | Build to last | Build to change |
| | Long development | Build and deployed |
| | cycles | incrementally |
| Resulting system | Application silos | Enterprise solutions |
| | Tightly coupled | Loosely coupled |
| | Object-oriented | Semantic message-oriented |
| | interactions | interactions |

SOA takes advantage of a technique called “Decomposition”. Decomposition is a technique formalized by classical system theory in the late 1950s. System theory states that the more complex a system is the more unknowns it contains and thus, the harder it is to automate it. This theory prescribes decomposing complex systems into smaller, more manageable ones that are easier to control, and then treating the whole system as a composition of its parts. The same applies to complex software development initiatives.

The first software decomposition divided mainframe applications into separate jobs, each implemented by a separate program. Later, each program itself was split into modules or subroutines, according to their function. The object-oriented (OO) paradigm introduced in the 1970s strengthened decomposition adoption by introducing objects, or modules of code, each of which implemented a model of a real thing.

In the continued search for a better design paradigm, a different approach to decomposition was introduced in the late 1990s: components. The idea was to fix the problems of OO by raising a level of abstraction, increasing granularity, and creating a tighter linkage with the business artifacts.

Introduction of software components allowed for the creation of flexible, better structured, and more manageable software applications. However, it did not solve the main architecture problem: its application-centric nature. Both objects and components provide better design and development approaches for individual applications. SOA brings decomposition to a higher level, as shown below. Instead of trying to decompose individual applications, it decomposes the entire architecture functionality. The following properties are described for the distributed systems architecture.

TABLE 2
Distributed Systems Architecture Properties

| Property | Description |
|---|---|
| Logical view | The service is an abstracted, logical view of actual |
| | programs, databases, business processes, and so on, defined |
| | in terms of what it does, typically carrying out a business- |
| | level operation. Service is defined as a business-meaningful |
| | action. |
| Message | The service is formally defined in terms of the messages |
| orientation | exchanged between provider and consumer, and not the |
| | properties of the provider and consumer themselves. |
| | The internal structure of implementation is deliberately |
| | abstracted away. Service interface is separated from the |
| | service implementation. |
| Description | A service is described by machine-processable |
| orientation | metadata/service definition. |
| Granularity | Services tend to use a small number of operations with |
| | relatively large and complex messages (payloads). |
| Network | Services tend to be oriented toward use over a network, |
| orientation | although this is not an absolute requirement. |
| Platform | Messages are sent in a platform-neutral, standardized |
| neutral | format delivered through the interfaces. XML is the most |
| | obvious format that meets this constraint. |

The main drivers for SOA adoption are that it links computational resources and promotes their reuse. However, despite the advantages of the SOA, the SOA has not been applied to IFE applications, and hence, the development of sophisticated IFE systems has been costly and slow.

### SUMMARY

A system is provided comprising a software architecture for integrating an in-operation entertainment system and a vehicle cabin functions system, comprising: a first network serving the in-operation entertainment system; a second network serving the vehicle cabin functions system; a first set of common functions being available via the first network; a second set of common functions being available via the second network; and at least one interface linking the first and second sets of common functions, the at least one interface being adapted to link at least one additional service to at least one of the first and second networks.

In IFE applications, the use of SOA allows the definition of a generic architecture for offering multimedia, VoIP, Internet, games, and any other present and future service where service enablers and common functions can be reused for multiple applications. In other words, the concept of a layered architecture for the IFE is taken one step further by defining a horizontal architecture in which the convergence of IT domain and multimedia services simplifies and speeds up the service creation and provisioning process without overlapping functionality, such as routing, list management, etc.

By implementing the SOA within the IFE, many functions can be reused. As an example, the application layer where various aspects of service control are defined, i.e., how service requests are routed (switchers), which protocols are supported, how billing is performed (if applicable), and how each service is enabled. A simple application layer may host multiple services for example audio-video on-demand (AVoD), telephony, games, Internet access, etc.

The layered architecture can be taken one step further by the definition of the horizontal architecture where service enablers and common functions can be reused for multiple applications providing control and security. In a traditional architecture, separate implementations of each layer must be built for every service and the structure is replicated across the network.

In the other hand, in an SOA, a number of common functions are generic in their structure and implementation and can be reused by virtually all services in the system. Examples of common functions are: QoS, topology discovery, security, directory, billing, provisioning, presence, network management, etc. Another feature is that the competence required is more generic and can be overlaid with service-specific knowledge instead of demanding specialist competence for each service.

### BRIEF DESCRIPTION OF THE DRAWINGS

The accompanying drawings, which are incorporated herein and constitute part of this specification, illustrate exemplary embodiments of the invention, and together with the general description given above and the detailed description given below, serve to explain features of the invention.

FIGS. 1A and 1B are diagrams illustrating examples of seating layouts for commercial aircraft in which an embodiment of the present invention may be employed;

FIG. 2 illustrates an example of an in-seat video player arrangement for the commercial aircraft as shown in FIGS. 1A and 1B;

FIG. 3 is a conceptual block diagram illustrating an example of an IFE system employed in an aircraft as shown in FIGS. 1A and 1B and which may employ an embodiment of the present invention;

FIG. 4 is a block diagram illustrating the difference between vertically integrated services and horizontal integration;

FIG. 5 is a block diagram illustrating the use of SOA for IFE and other services in an embodiment of the invention; and

FIG. 6 is a conceptual block diagram illustrating an embodiment of software architecture according to the present invention illustrating a segregation between IFE and cabin function services.

### DETAILED DESCRIPTION OF EMBODIMENTS

### Cabin Layout and IFE Background

Embodiments of the present invention provide an IFE system in which service oriented software architecture is located in the environment of a vehicle cabin. The IFE system is capable of presenting video and associated audio to multiple presentation devices, such as multiple video players and multiple audio headsets in an IFE system in a vehicle. This environment is typically an airplane, train, bus, boat, ship, or other multi-passenger vehicle where there are multiple overhead video monitors being viewed by multiple passengers who listen to the audio associated to the overhead video program through a headset plugged into an audio jack local to the passenger's seat. The IFE system thus is capable of providing audio and/or visual content to a large number of locations in the vehicle cabin, and the cabin function system is capable of providing various cabin applications, e.g., lighting level control, attendant calling, air conditioning control, etc. at different locations in the vehicle cabin.

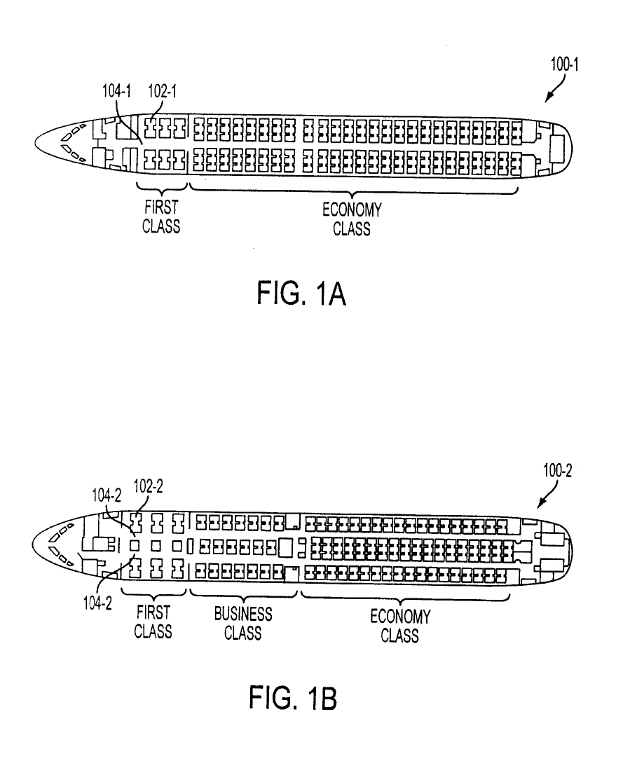

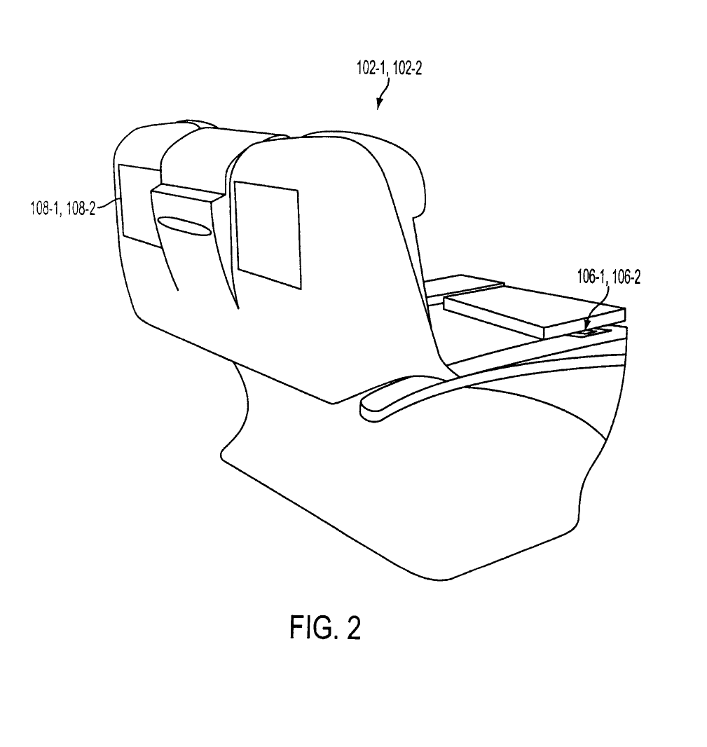

FIGS. 1A and 1B illustrate examples of typical seating arrangements for two different aircraft 100-1 and 100-2. As shown, the environment of an IFE system for the aircraft 100-1 or 100-2 includes a densely packed population of passenger seats 102-1 or 102-2 (hereinafter generically referred to as a seat or seats 102) organized into rows and columns. Seats are typically organized into groups of from 2 to 4 side-by-side seats, and seat groups are placed into long rows running between the front and back of the aircraft. Short distance aircraft 100-1 typically have two rows of seat groups with the center aisle 104-1 for access. Longer distance aircraft 100-2 typically have three rows of seat groups with two aisles 104-2 for access. As shown in FIG. 2, each passenger seat 102 is provided with a headset jack 106-1 or 106-2 (hereinafter generically referred to as headset jack or jacks 106) into which an audio headset can be plugged.

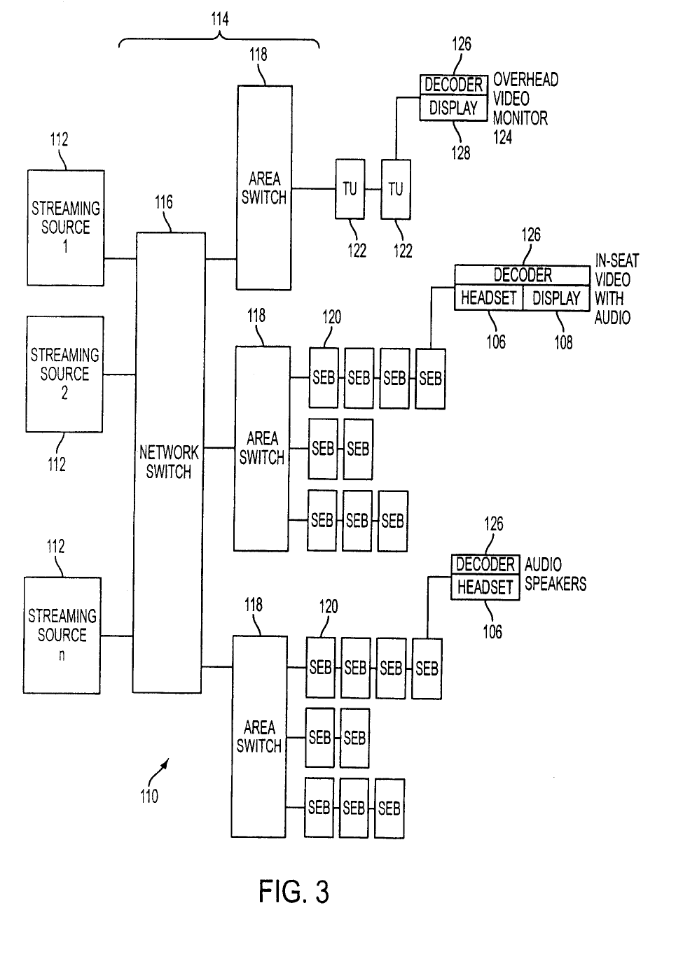

Entertainment audio is typically presented to each passenger over their respective headset. Entertainment video is typically presented to passengers in two different ways, either via overhead video monitor 124 (see FIG. 3) or via an in-seat video player 108-1 or 108-2 (see FIG. 2). In the overhead video arrangement, an aircraft 100-1 or 100-2 is fitted with a number of overhead video monitors 124 to which a video program can be supplied. Overhead video systems have evolved from those which provided a single video projector in each class of the aircraft cabin to current systems which provide a large number of individual monitors hung from the ceiling or baggage bins. In current systems, each passenger can choose to watch the overhead monitor most convenient for their personal viewing.

In the in-seat video player arrangement, the aircraft 100-1 or 100-2 is equipped with individual video players 108-1 or 108-2 (hereinafter generically referred to as a video player or players 108) for each passenger seat 102, as shown in FIG. 2, which provides each passenger with an individualized entertainment experience. It is common to combine both types of video presentation into an aircraft, and it is also common to differentiate service to different passenger classes (e.g., in-seat video for first and business classes, and overhead video in economy class). In either case, the overhead video monitors and in-seat video players 108 communicate with an IFE system 110 as shown in FIG. 3.

An example of the physical architecture of the digital network in a typical IFE system 110 is further illustrated in FIG. 3. The basic components are a set of head end streaming sources 112, a distribution network 114 that can include one or more network switches 116 and a plurality of area switches 118, and columns of seat components such as seat electronic boxes (SEBs) 120 and tapping units 122. The streaming sources 112 may be digital servers (e.g., preloaded with MPEG digital content) or may be real-time encoders capable of converting input video and audio into MPEG data. The network switch 116 can be, for example, a layer 2 or layer 3 Ethernet switch, and is configured to connect any of the streaming sources 112 to any component of the IFE system 110 of the aircraft. An area switch 118 is provided in each area of the aircraft 100-1 or 100-2 to connect the network switch 116 to multiple columns of seats. In this example, each area switch 118 connects to three seat columns, but the number of seat columns to which an area switch 118 connects can vary as desired.

Each seat group as discussed above is fitted with an SEB 120, and the components at the seats 102, such as the video players 108 and headset jacks 106, are wired from an area switch 118 through a number of SEBs 120 arranged in a seat column. As can be appreciated by one skilled in the art, an SEB 120 extracts data packets intended for locally attached players (decoders) and passes other packets through to the next SEB 120 in the seat column as required.

As further shown in FIG. 3, each overhead monitor 124 typically includes or is associated with a decoder 126 and a display 128. The overhead monitors 124 are, in this exemplary arrangement, connected to the IFE system 110 through a set of tapping units (TU) 122 that perform the same or similar functions as the SEBs 120. As also shown, each headset jack 106, and in-seat video player 108, includes or is associated with a decoder 126 that is connected to an SEB 120 as discussed above.

Many IFE systems 110 have multiple video programs stored on a streaming source 112. When playback is desired, a video player (e.g., video player 108 or overhead monitor 124) obtains the material from the streaming source 112 and decodes the compressed content into a presentable form. If the material is to be presented on overhead monitors 124 or in a video announcement that is to be simultaneously viewed by all passengers, the material typically can be decoded by a single player and distributed to all monitors using an analog distribution technique, e.g., through RF modulation or baseband distribution technologies. If the material is to be presented to a passenger on an individual basis (e.g., Video on Demand) then the passenger has a dedicated player (e.g., a video monitor 108), which can obtain a compressed digital program and decode it specifically for the passenger.

To support a broadcast program, a streaming source 112 would typically transmit a digital stream throughout the digital network of the IFE system 110 using a network protocol appropriate for a one-to-many relationship. As can be appreciated by one skilled in the art, typically TCP/IP communications can be used for one-to-one communications. Also, a one-to-many network protocol, commonly referred to as a “multi-cast,” can be combined with a fixed rate streaming protocol such as a Real-Time Protocol (RTP).

As can further be appreciated by one skilled in the art, multicast on an IP network typically assigns each multicast program a specific multicast IP address. The streaming source 112 can then transmit the program onto the network (e.g., using RTP) with, for example, a broadcast layer 2 address and the assigned multicast layer 3 address. The network of the IFE system 110 can make this stream available to all network devices, such as video player 108 and overhead monitors 124. A player (e.g., video player 108) can present this program by “subscribing” to the program using the IGMP protocol specifying the desired multicast IP address. This process permits the streaming source to transmit a single data stream and have it received by all desired players on the network.

The example of the data network architecture described above with regard to FIG. 3 enables a streaming source 112 to produce a single packetized video/audio stream which is available to all desired video players 108 and overhead monitors 124 in the aircraft 100-1 or 100-2. This arrangement allows for a personal, in-seat presentation of a common source program to requesting passengers.

### Application of SOA to IFE System

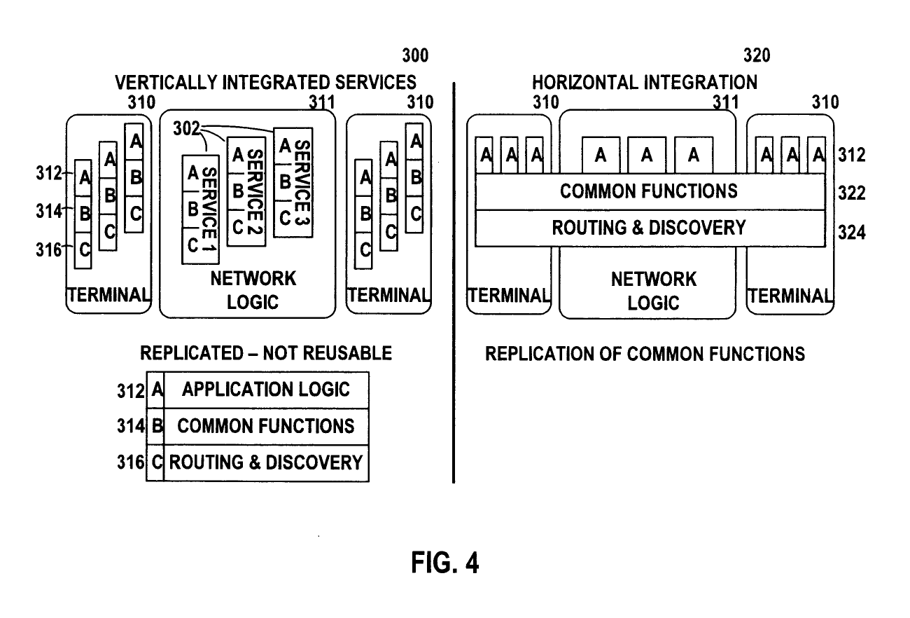

As noted above, and as illustrated in FIG. 4, a traditional architecture 300 requires, separate implementations of each layer (application logic 312, common functions 314, and routing and discovery functions 316) must be built for every service 302 and the structure is replicated across the network 311. The layers must also be provided in the terminals 310.

In the other hand, in an SOA 320, a number of common functions 322 and routing and discovery functions 324 are generic in their structure and implementation and can be reused by virtually all services in the system. Thus, only the application logic 312 need be developed, and this can rely upon the lower level common elements 322, 324.

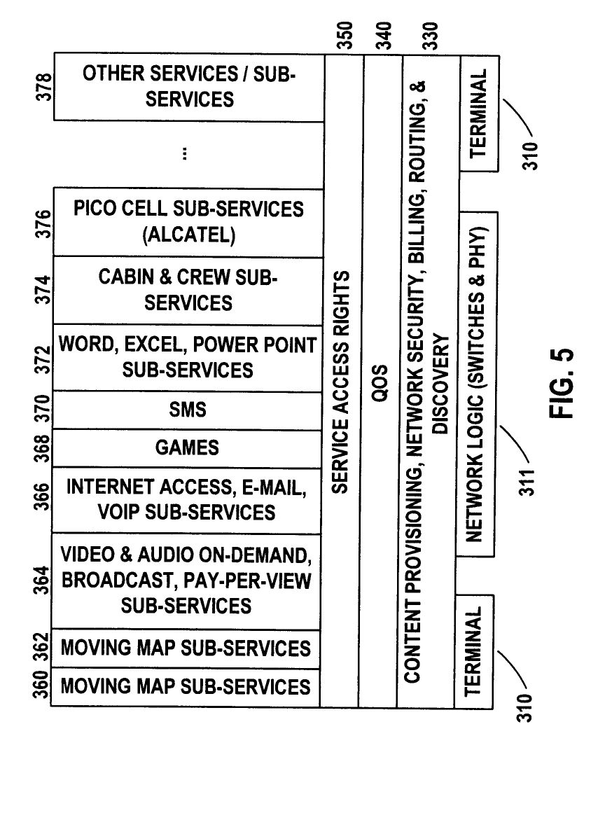

FIG. 5 illustrates the how service oriented software could be introduced in an architecture according to an embodiment of the invention. Moving map sub-services 360, 362 can be provided to show the passengers the location of the vehicle with respect to a map that moves along with the vehicle.

Video and audio services 364 could have three different sub-services: AVoD (audio and video on demand), broadcast, and pay-per-view. In AVoD, the customer (pax) may be able to access a catalog of movies and, once the customer has confirmed his/her selection, the network could start to stream the chosen content. On the broadcast application, all customers receive the same content. In a pay-per-view application, the customer can choose premium content and pay for it using a credit card.

A bundle of Internet services 366 can offer voice-over-Internet (VoIP), integrated by using any commercial VoIP solution, like Cirpaq, e-mail, SMS 370, and other types of Internet access. The Internet service 366 may use wired or wireless connectivity-its implementation does not depend on any particular underlying technology. Games 368 can be provided that the user either plays alone or with others over the network. The hardware interface to the outside world could be provided by satellite or by terrestrial to air connectivity.

Cabin and crew sub-services 374, such as the public address PA/VA function can be implemented to manage the PA/VA announcement addressed to the whole aircraft, all passengers, or a subset of the passengers only. These functions could be added to all crew and cabin function 374 forming a cabin service that has priority over the physical network in respect to other services. Pico cell subservices 376, such as Alcatel, and other services and sub-services 378, can further be provided. All of the services that exist or can exist in an airplane as well as all of the outside supporting services can be provided as a set of functions and components of the desired service architecture.

The objective in an SOA is to reduce the dependencies between services, and improving the reuse and the efficiency of the services provided. The common functions 330, 340, 350 are used by all services 360-378 and in the horizontal architecture, they should not be replicated in every service. The result is a lean software structure based on services that share the same set of common functions. In fact, services can be seen as the ending points of the system, presented to the aircraft system, the flight attendant, the maintenance engineer, and the passengers. All functions existing today, such as APA, PSS, data acquisition, etc. can remain in the system built on the services that they are related to.

The Quality of Service (QOS) 340 function is discussed as an example of some of the common functions that can fit in a SOA.

QOS 340 can be defined in many different ways. It can be defined as the server or application response time, the availability of a given application service, or the ability to provide differentiated services based on the user type. For example, it may be desirable to have a Web site that provides frequent-flier program information provide a better response time to its platinum members than its gold or silver members. Load balancers can be used to distinguish the users based on some information in the request packets, and direct them to a server or a group of servers, or to set the priority bits in the IP packet to provide the designated and desired class of service.

This process can be applicable to any service demanded by the client and, therefore, provide not just the known QoS, a service with lower outage or higher quality but also a differentiation of client and services through content provisioning 330. For example the system could be designed to provide High Definition video to first and business class, and standard definition to coach. A further differentiation could be made in coach to provide access to certain premium services to frequently fliers with more mileage. Choice of meal and other privileges could also be made available, and a well designed service could advantageously reduce the work load of the crew. The common functions could include network security, billing, and as discussed above, routing and discovery 330. Service access rights 350 can also be established as a common function.

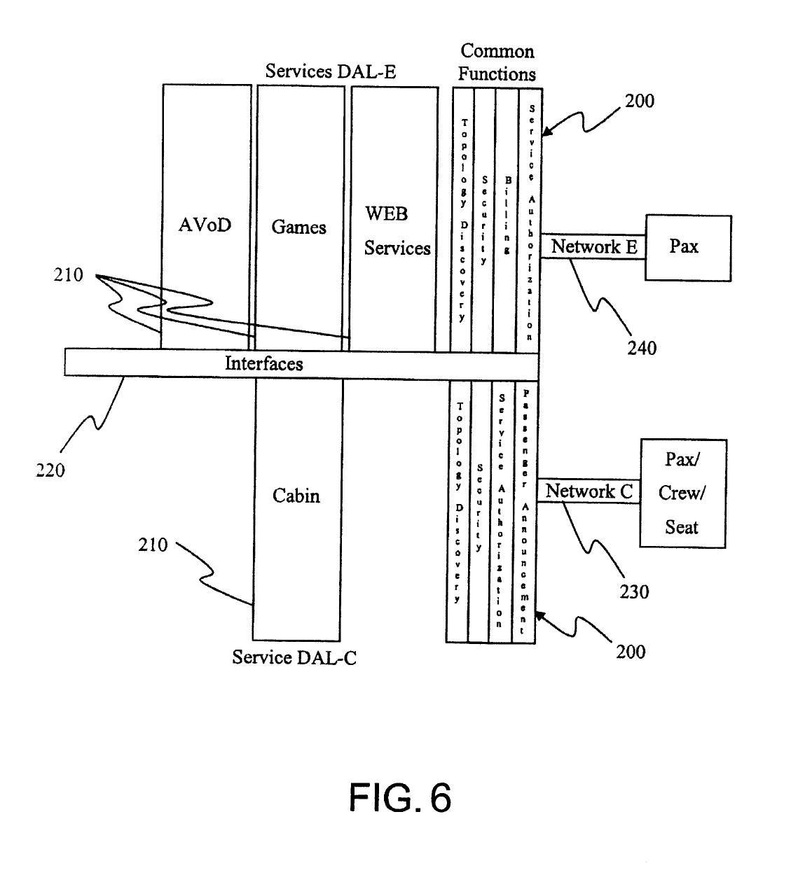

Referring to FIG. 6, software architectures according to an embodiment of the present invention provide for a splitting of the functions related to an IFE network 240, which includes all entertainment and passenger services, and a cabin functions network 230, which includes services relating to the cabin of the vehicle, such as the PA system, lighting, cabin control, etc.

FIG. 6 illustrates that one can divide tasks in a layer of common functions 200, which include the aspects of the IFE and cabin systems that are required by both, and a horizontal architecture that allows new services 210 to be plugged into an interface 220 with the common functions layer 200. Accordingly, each service 210 can stand and evolve independently from one another. In particular, each application may run independent of the network and of the passenger hardware, and at the same time meet the IFE requirements. The segregation of the IFE network 240 and services DAL-E and the cabin functions network 230 and services DAL-C is discussed in more detail in U.S. Provisional Application No. 60/924,101, filed Apr. 30, 2007, and its related U.S. non-provisional patent application, entitled, “Server Design and Method”, filed concurrently herewith, and identified by the Applicant's docket reference no. P2749US, both herein incorporated by reference.

The architecture and method according to embodiments of the present invention reduces the interdependencies between services 210 by giving each service 210 a single point of connection to the common functions 200 and then to its respective network 230, 240.

The architecture according to the present invention also allows independent evolution and scalability of each service 210 because the independent interfaces 220, i.e., an interface 220 that is not shared with another service 210, allow individual services 210 to be plugged into the system without requiring the use of any component from any other service 210.

According to various embodiments of the present invention, the cabin service oriented architecture design provides a method to manage and to interface the cabin devices to the cabin functions digital access layer (DAL-C) network 230. The qualification requirement may be the DAL-C standard.

The interface design is ideally based on generic semantics from IFE requirements and therefore shares descriptive messages, vocabulary, and structure. This minimizes messages that describe the system behavior and provides descriptive messages that can work across platforms.

The architecture may be extensible within limits that are based on the set of descriptive messages, vocabulary, and structure. Thus, the architecture permits adaptation for evolving services 210 and at the same time increases communication efficiency.

For the purposes of promoting an understanding of the principles of the invention, reference has been made to the preferred embodiments illustrated in the drawings, and specific language has been used to describe these embodiments. However, no limitation of the scope of the invention is intended by this specific language, and the invention should be construed to encompass all embodiments that would normally occur to one of ordinary skill in the art. For example, the term “in-flight” is defined to include the meaning “in-operation” when the vehicle is not an aircraft.

The present invention may be described in terms of functional block components and various processing steps. Such functional blocks may be realized by any number of hardware and/or software components configured to perform the specified functions. For example, the present invention may employ various integrated circuit components, e.g., memory elements, processing elements, logic elements, look-up tables, and the like, which may carry out a variety of functions under the control of one or more microprocessors or other control devices. Similarly, where the elements of the present invention are implemented using software programming or software elements the invention may be implemented with any programming or scripting language such as C, C++, Java, assembler, or the like, with the various algorithms being implemented with any combination of data structures, objects, processes, routines or other programming elements. Furthermore, the present invention could employ any number of conventional techniques for electronics configuration, signal processing and/or control, data processing and the like. The word mechanism is used broadly and is not limited to mechanical or physical embodiments, but can include software routines in conjunction with processors, etc.

The software components may be run on a computer comprising a processor, memory, such as read-only (ROM) and random access (RAM) memory, and may interface with storage devices of a non-volatile nature, such as hard disks, CD-ROM, DVD, etc. The computer may interface with a network using various networking hardware. User interface devices, such as keyboard inputs, and output devices, such as display screens may be further incorporated with the computer. Any software components may be stored on a storage media such as tape, disk, CD-ROM, DVD, or in memory, and may be loaded into the computer memory for execution by the processor.

The particular implementations shown and described herein are illustrative examples of the invention and are not intended to otherwise limit the scope of the invention in any way. For the sake of brevity, conventional electronics, control systems, software development and other functional aspects of the systems (and components of the individual operating components of the systems) may not be described in detail. Furthermore, the connecting lines, or connectors shown in the various figures presented are intended to represent exemplary functional relationships and/or physical or logical couplings between the various elements. It should be noted that many alternative or additional functional relationships, physical connections or logical connections may be present in a practical device. Moreover, no item or component is essential to the practice of the invention unless the element is specifically described as “essential” or “critical”. Numerous modifications and adaptations will be readily apparent to those skilled in this art without departing from the spirit and scope of the present invention.

1. A system comprising a software architecture for integrating an in-operation entertainment system and a vehicle cabin functions system, comprising:
a first network serving the in-operation entertainment system;
a second network serving the vehicle cabin functions system;
a first set of common functions being available via the first network;
a second set of common functions being available via the second network; and
at least one interface linking the first and second sets of common functions, the at least one interface being adapted to link at least one additional service to at least one of the first and second networks.

2. The system according to claim 1, wherein each additional service operates independently of any other additional service and of any other common function.

3. The system according to claim 1, wherein the at least one additional service is interchangeably connected to the at least one interface.

4. The system according to claim 1, wherein the at least one additional service is linked by the at least one interface to the first network, and the at least one additional service comprises at least one of access to audio and video on demand, access to games, and worldwide web access.

5. The system according to claim 1, wherein the common functions comprise functions for implementing at least one of quality of service, topology discovery, security, directory, billing, provisioning, presence, and network management.

6. The system according to claim 5, wherein the common functions comprise a function for implementing a quality of service that differentiates system services according to a passenger classification or designation.

7. The system according to claim 6, further comprising a load balancer that distinguishes between passengers on information in request packets, the load balancer providing at least one of directing the passengers to a server or group of servers and setting priority bits in an IP packet to provide a designated class of service.

8. The system according to claim 1, wherein the second network, the second set of common functions, and an additional service of the second network take priority over the first network, the first set of common functions, and an additional service of the first network.
